(19) United States
(12) Patent Application Publication
(10) Pub. No.: US 2008/0117861 A1
(43) Pub. Date: May 22, 2008

(54) Service provision and management for mobile communities

(76) Inventors: Elena Balandina, Helsinki (FI); Sergey Balandin, Helsinki (FI)

Correspondence Address: SQUIRE, SANDERS & DEMPSEY L.L.P., 8000 TOWERS CRESCENT, 14TH FLOOR, TYSONS CORNER, VA, 22182-2700, US

(21) Appl. No.: 11/600,141

(22) Filed: Nov. 16, 2006

(51) Int. Cl. H04Q 7/00

(52) U.S. Cl. 370/328

(57) ABSTRACT

The present invention relates to service provision and management for mobile communities. There is disclosed a scalable service creation, provision and management scheme as well as a community management scheme for mobile communities such as for example peer-to-peer (P2P) communities.

### FIELD OF THE INVENTION

The present invention relates to service provision and management for mobile communities. In particular, the present invention relates to scalable service creation, provision (distribution) and management as well as to services of community management in mobile communities such as for example peer-to-peer (P2P) communities.

### BACKGROUND OF THE INVENTION

In recent years, the currently dominating conventional operator-centric service provisioning model has been challenged by decentralized service provisioning schemes. Such schemes are logically based on the peer-to-peer (P2P) networking paradigm, under which groups of users of the network constitute a so-called community, i.e. a subset of users that for example share the same interests. A network community might be seen as a logical overlay on top of a communication network. The common interest could for example reside in file sharing, telephone services, or the like. Especially in fixed networks like in the Internet, suchlike P2P communities have recently emerged, examples for which include Gnutella, Skype, Aron, BitTorrent, etc. Actually, these communities are all different services implemented on a peer-to-peer network organization. Such a service provisioning scheme on the basis of P2P services may be referred to as a community-based service provisioning model.

P2P services have advantages over conventional services. A key advantage of this community-based service provision model is that the community itself acts as a service provider, so the service can be better customized to the needs of the community members and thus be more dynamic.

A next step in the emerging area of service creation and deployment in communities is a migration from fixed networks to the mobile space, i.e. mobile networks. However, a further progress in this field is constrained by a number of political, legal and technical problems, wherein the technical problems are addressed in the following.

A first issue relates to a scheme of service provision, creation and management. Some of the key obstacles on the way of efficient development of new services for mobile communities are deployment complexity, resource limitations of the involved mobile devices and communication channels, and a fear of the community members that deployment of the new services will result in unbalanced access to the community resources.

However, known service provision schemes, which are directed to fixed network communities, are not able to achieve the requirements of mobile communities. The currently used service creation schemes for example require that the service access blocks of code must be first delivered to the entities that participate in service creation (e.g. by installing corresponding sis files) and only after that the service is available for use. This scheme of service deployment in the community is not scalable and also it is quite resource consuming as it permanently takes some resources (at least memory) of all involved peer nodes.

Consequently, one of the key problems is to define a scheme of scalable service provision (distribution), so that new services could be easily added to the community by any authorized party (e.g. community member). A second issue relates to a management solution for mobile communities. In this regard, a well recognized factor that limits diversity and quality of the services provided by the mobile communities is lack of community management infrastructure. The community management for example should guarantee fair access to the community resources by all community members, has to maintain continuous availability and quality of the services, to protect private life of the community, and so on. In the area of network management solutions, there are known architectures of (manager-agent) centralized type, such as for example the Simple Network Management Protocol (SNMP), and of decentralized type, which are based on management by delegation and mobile management agents.

However, traditional network management systems are not suitable for mobile communities. This is for example due to the fact that known network management systems base quality guarantees on resource reservation, which is unacceptably expensive in a mobile environment, and the network management protocol and agents are not resource efficient. Further, they rely on a well established planning of available network resources, which is not possible in a mobile communication environment. Hence, as some key assumptions underlying traditional (network) management systems are not applicable to mobile communities, such systems are not suited for overcoming their inherent problems.

Consequently, in addition to the definition of a scalable service provision scheme, another key problem is to develop an efficient and robust management solution for mobile communities.

Thus, a solution to the above problems and drawbacks is needed for overcoming the obstacles on the way towards a scalable service provision scheme and a management solution for mobile communities.

### SUMMARY OF THE INVENTION

Consequently, it is an object of the present invention to remove the above drawbacks and to provide an improved solution for service provision and management for mobile communities.

According to a first aspect of the invention, this object is for example achieved by a scalable service provision and management scheme.

According to a second aspect of the invention, this object is for example achieved by a community management scheme.

The thus proposed service provision scheme provides a robust and clearly defined mechanism for creating and executing new services in a mobile community, for example a mobile network.

The service provision scheme according to embodiments of the present invention may be used for porting and further personalization of existing services to a mobile network environment as well as for easily creating and deploying new services within a community, where any user can be a service initiator.

It is an advantage of the service provision scheme according to embodiments of the present invention that it creates a flexible and scalable agent-based service provision scheme. This scheme is suited to mobile communities, as it allows community members to freely and easily develop and use services that reflect technical, organizational and/or social requirements of the community. The proposed scheme is further able to be deployed on only some of community members, while still bringing advantage to the community.

Furthermore, there is provided a scalable and flexible management solution for mobile communities, providing integration with network management.

The general principles of the mobile agent-based community management are advantageously applicable to a new type of inter-community management, which results in increasing efficiency of resource utilization and creates a robust management framework which is able to provide adaptive responses to events within a community (without knowing all possible scenarios beforehand).

The proposed extension to the two layer community management architecture provides full compatibility with traditional (e.g. SNMP-based) network management solutions. The presented solution further allows participation of the network operator and commercial service providers in the community management and service creation and maintenance chains, if so configured.

Additionally, the proposed schemes are suitable for managing communities with short-term and long-term lifecycles, and provide high efficiency in both flat and hierarchically structured mobile communities.

The proposed schemes are further able to minimize processing and communication overhead, to tolerate mobility of nodes, and to ensure a cooperative inter-working between applications on different nodes.

### BRIEF DESCRIPTION OF THE DRAWINGS

In the following, the present invention will be described in greater detail with reference to the accompanying drawings, in which

FIG. 1 illustrates a schematic block diagram of a peer structure on which embodiments of the present invention are applicable,

FIG. 2 illustrates another representation of a schematic block diagram of a peer structure on which embodiments of the present invention are applicable,

FIGS. 3A and 3B illustrate a schematic block diagram of a hierarchical and flat intra-community organization, respectively, according to an embodiment of the present invention,

FIG. 4 illustrates a schematic flow diagram of a service provision scheme according to an embodiment of the present invention, and

FIG. 5 illustrates a schematic block diagram of a community management structure according to an embodiment of the present invention.

### DETAILED DESCRIPTION OF EMBODIMENTS OF THE PRESENT INVENTION

The present invention is described herein with reference to particular non-limiting examples. A person skilled in the art will appreciate that the invention is not limited to these examples, and may be more broadly applied.

In particular, the present invention is described in relation to a certain exemplary mobile peer-to-peer (P2P) architecture. As such, the description of embodiments given herein specifically refers to terminology which is directly related to peer-to-peer networking in the framework of the exemplary architecture. Such terminology is only used in the context of the presented examples, and does not limit the invention in any way. Rather, embodiments of the present invention are also applicable to some other mobile P2P architectures, as long as the underlying principles of mobile communities are realized.

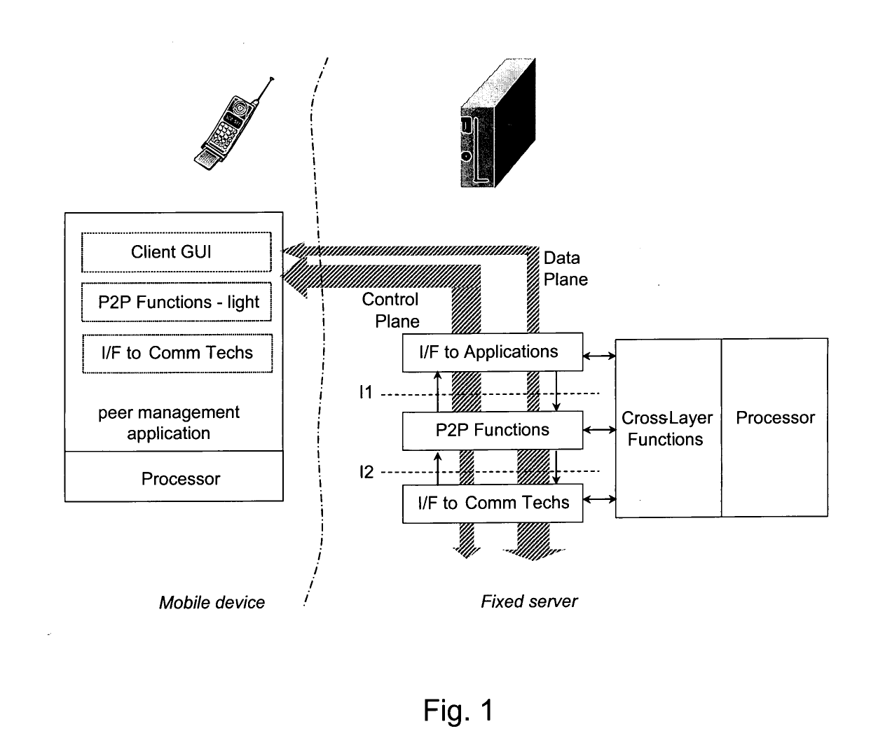

For a better understanding of the subsequent description, FIG. 1 illustrates a schematic block diagram of a peer structure on which embodiments of the present invention are applicable.

The basic peer structure of a mobile peer-to-peer architecture according to FIG. 1 basically comprises a mobile device module (also referred to as mobile service module), i.e. a mobile peer management application, in a mobile device of the peer and a number of optional fixed server modules (also referred to as fixed network modules), i.e. back-end modules, in a server or servers in a fixed overlay network. The peer management application is located at the mobile device and the back-end processing unit is located at a fixed server connected to the fixed overlay network, and they are interconnected via a control and data plane interface. The peer management application on the mobile device may comprise three layers. The lower layer (denoted by “I/F to CommTechs”) provides a communication interface towards the back-end module and implements a set of control primitives for installing and managing existing and new services on the mobile device. The middle layer (denoted by “P2P Functions-light”) may implement a reduced version of the peer's community functionality, which at least includes the mobile peer management application block. This module also stores the user's most confidential data and services. The upper layer (denoted by “Client GUI”) implements application-specific functionalities and a graphical user interface (GUI). The back-end module on the fixed server implements a common platform for executing P2P services, optionally stores a part of the peer's database and processes service requests from other peers. The back-end module comprises an upper layer illustrating an interface to applications (such as the peer management application at the mobile device), a middle layer illustrating peer-to-peer functions and a lower layer illustrating an interface to communication technologies. These layers are interconnected via cross-layer functions.

Both the mobile device module and the fixed server module are controlled by a processor, respectively. The processor in each of the modules also serves for performing other functions as described below.

As the illustration of FIG. 1 is largely self-explaining in terms of understanding the present invention, no further explanations are given herein.

An example deployment and implementation of embodiments of the present invention will be given on the basis of definitions of mobile peers and community organization including knowledge organization within communities, which are either in line with FIG. 1 and/or are known to those skilled in the art of mobile P2P networking. For example, the Session Initiation Protocol (SIP) may be employed for signaling between modules and peers.

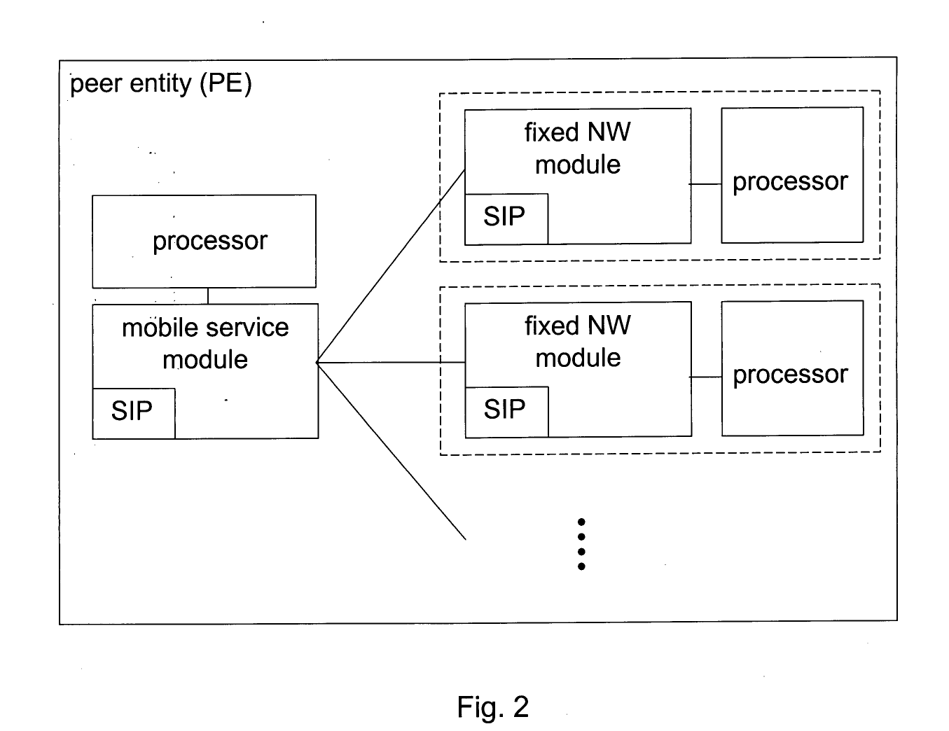

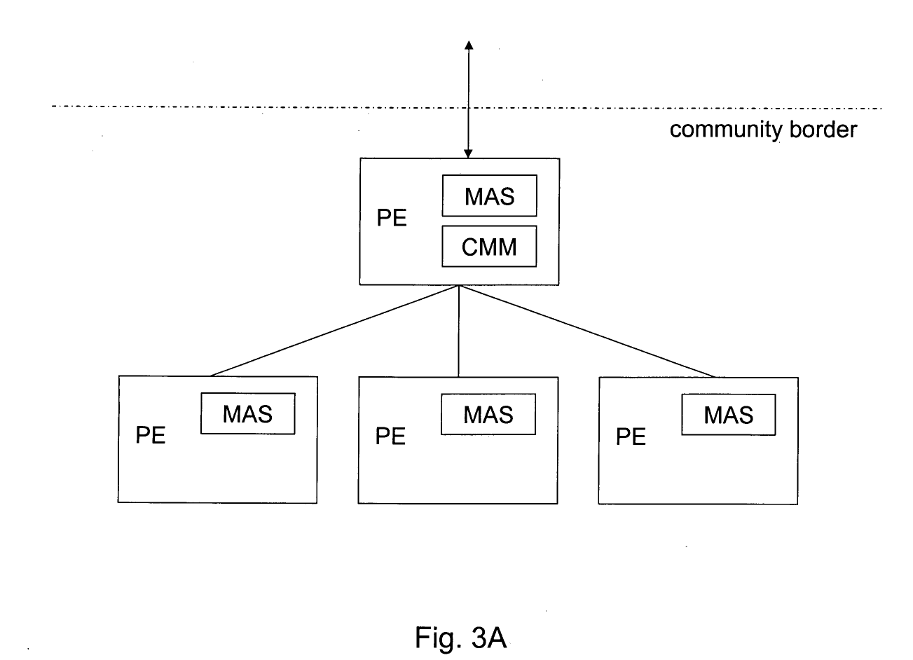

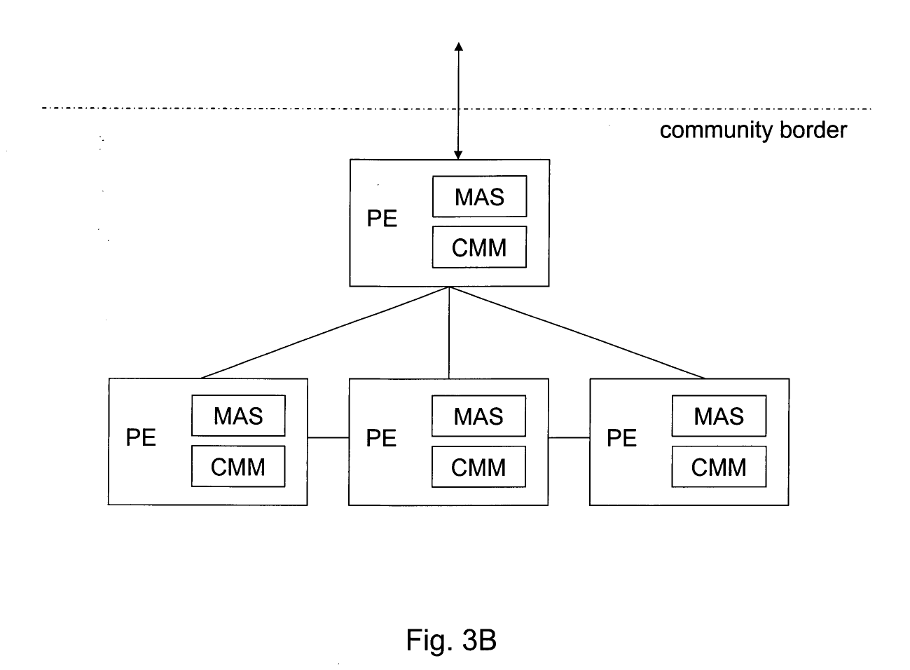

For a better understanding of the below description, FIGS. 2 and 3 are explained as a basis for a peer entity and community organization, on which embodiments of the present invention are applicable.

FIG. 2 illustrates another representation of a schematic block diagram of a peer structure on which embodiments of the present invention are applicable. According to FIG. 2, a peer entity PE comprises a mobile service module (corresponding to a mobile device module according to FIG. 1) and a number of fixed network (NW) modules (corresponding to fixed server modules according to FIG. 1). These fixed NW modules may reside on one or a plurality of servers, wherein FIG. 2 exemplifies a case where every fixed NW module resides on a distinct server (as indicated by broken-line blocks). Any one of these modules includes a service interpretation platform SIP, which might be understood as an overlapping element deployed on top of the mobile and fixed modules. The different modules are controlled by processors, e.g. each module is controlled by a distinct processor (as exemplarily illustrated in FIG. 2). The processors also serve for performing other functions as described below.

FIG. 3 illustrates different types of intra-community organization according to embodiments of the present invention.

FIG. 3A illustrates a schematic block diagram of a hierarchical intra-community organization according to an embodiment of the present invention. All of the four peer entities depicted in FIG. 3A belong to the same community. All of them include a mobile agent server MAS, which enables each of the peer entities to form mobile agents (i.e. to search for services, for example), but only one of them (i.e. the “master”) includes a community management module CMM. The master peer entity constitutes an interface to the outside of the present community, and manages the community in a hierarchical manner.

FIG. 3B illustrates a schematic block diagram of a flat intra-community organization according to an embodiment of the present invention. All of the three peer entities depicted in FIG. 3B belong to the same community. All of them include a community management module CMM as well as a mobile agent server MAS. Any one of the peer entities constitutes an interface to the outside of the present community. All of the peer entities are connected to each other for performing a number of inter-CMM management operations, thus conjointly managing the community in a flat manner.

[Service Provision in Mobile Communities]

According to an embodiment of the present invention, there is proposed a scheme of service creation, provision (i.e. distribution) and management in mobile P2P communities.

The thus proposed service provision scheme, also referred to as service management application, manages the interface between the mobile community application (the peer management application) and service provision middleware distributed across the peer's management device (i.e. mobile device) and the back-end on the network side. It is suitable for installing and controlling (P2P) services and for providing e.g. a GUI to the user as well as application-specific functions.

In general terms, the actual service applications managed by the service management application are interpretable code (for example written in Java or any other suitable programming language). The service provision scheme is based on allowing transferring both—interpretable code of the service program and data. The services can be supplied to the consuming (requesting) peer either by distributing the interpretable code or by exchanging service orders and deliverables (i.e. replies to service orders) between the client peer and one or more service provision peers.

That is, according to the proposed solution, there are two options for realizing service provisioning at a requesting peer. From the network perspective, the two options will be considered as two different services, and will be handled accordingly.

As a first option, the service requestor gets an interpretable version of the requested service application for local execution. For example, if the requested service is a machine translation of a text, the service requesting peer requests and receives a translation service (i.e. translation software) and then runs this service (i.e. software) on its own mobile device and/or back-end module. As a second option, the service requester sends a service request (also referred to as service order) and receives the deliverable (i.e. service processing delivery) as a response, i.e. a service processing result. In the above example of a requested machine translation of a text, the service requesting peer sends the text in the original language to some other peer within the community and receives the translated text, wherein the translation has been performed by the requested peer having available the necessary service (i.e. translation software).

Accordingly, the thus proposed scheme requires that all service applications (i.e. service programs) are interpretable on every one of the involved peers, and that every service gets a unique service ID. Any peer needs a service agent interpretation module (e.g. a Symbian application) capable of interpreting the received service code to be installed thereon, in order to be able to enter the proposed service provision scheme. According to FIG. 2 above, such a service agent interpretation module is referred to as service interpretation platform SIP.

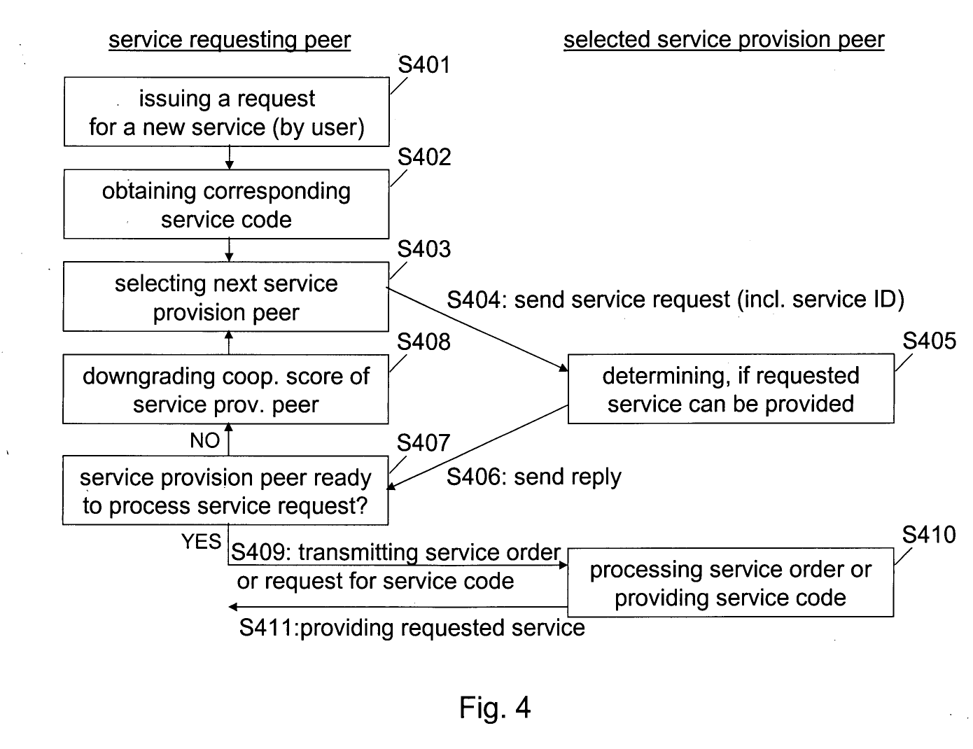

FIG. 4 illustrates a schematic flow diagram of a service provision scheme (protocol) according to an embodiment of the present invention. In more detail, the proposed service provision scheme (protocol) operates as follows.

When a user (i.e. a community member) issues a request for a new service (S401), the operation first obtains the corresponding service code (i.e. service program) uniquely identified by the service ID (S402). Depending on configuration settings associated with the selected service (or related group of services) and the data provided as a part of the service request the next service provision peer is selected (S403). Namely, a peer within the community is selected, which is the best known candidate to provide the requested service. Such a selection is made using the peer's own database and also might use other sources of information, for example local management information base (MIB), or the service providing peer can be located and selected using known peer-to-peer propagating search techniques. These searches may use cooperativeness scores for selecting peers with higher reliability to successfully provide the service. One such class of methods is to send mobile agents, which will roam the community looking for the requested service.

For service execution, in a next step (S404), a request for the necessary service is sent with the given service ID to the selected peer. The selected peer employs computer code running on a processor (which can be of any known type) to determine, if it can provide the requested service (S405). In step S406 of FIG. 4, the selected peer responds to the request by sending a reply to the requesting peer, which indicates whether the selected peer is ready to process the service request. The reply may also indicate, if the selected peer contains program code (i.e. an application agent) for the requested service.

If the selected and requested peer is not ready to process the new service request (NO in step S407), the service requester may downgrade a cooperativeness score of the peer (S408). Then, the service requestor repeats a similar procedure with the next service provision peer which is selected as a substitute for the previously selected peer (S403).

Otherwise, if respective service agent code is available at the service provision peer (YES in step S407), which is indicated in its reply to the requesting peer, then only service data is transmitted in step S409 from the requesting peer to the selected service provision peer (i.e. service order). The response therefrom is a deliverable as described above. A cooperativeness score may be upgraded now, or after completing the service provision successfully (not shown in FIG. 4). If the selected and requested peer is ready to process the new service request, then service code (i.e. interpretable code) is alternatively transmitted in step S409 from the selected service provision peer to the service requesting peer. In dependence on the kind of provision in step S409 (i.e. interpretable code or service order/deliverable), one of the two above-mentioned options for service provisioning is realized (S410 and S411).

Above, no distinction is made between processing in the mobile device module and the back-end modules of the peers concerned. It is further to be noted that the service provision scheme according to further embodiments of the present invention may also comprise only a subset of steps as illustrated in FIG. 4, these steps may be arranged in any meaningful order.

Furthermore, if needed, the selected requested peer can also act as an intermediate node and ask some further peer or peers for assistance in the service processing. In this case, the described above procedure is repeated, but the intermediate peer acts as an originator, i.e. as a service requester towards the further peer or peers. As a result, the service is provisioned via the intermediate peer to the actual originator, i.e. the original service requester. Thereby, a load distribution within the community of the involved peers is easily implemented.

The above-described scheme may be operated with or without virtual instances at the peers, the task of which is to reduce load on mobile devices. The use of such virtual instances would however make the service provision more efficient. In this context, a virtual instance is a software representation of a peer which is empowered to act on behalf of the peer (very similar to a back-end module), for example when the peer has limited connectivity to the network. For example, the virtual instance can consist of a directory of files and rules related to sharing the files, so that the virtual instance can share the files when the physical peer has the terminal switched off. To other users it would just appear that the peer/service is available.

[Mobile Community Management]

According to an embodiment of the present invention, there is proposed a scheme for managing mobile P2P communities. This management solution is based on principles similar to those described above in conjunction with service provision. Specifically, community (or network) management according to the present embodiment is built as a special type of service on top of the framework of the above-described scheme.

The internal peer and community management systems use similar principles to those defined above for the general service provision and management. The community overlay network requires an independent management, which in most cases is reasonable to integrate with the network management system used in the underlying and directly attached communication networks. This integration also provides a convenient control point for the community.

Accordingly, the community management is most efficiently built on a two layers model.

An upper layer is for managing overlay network-related issues, i.e. how the community in question accesses network resources, e.g. of a cellular overlay network. That is, the upper layer handles a physical linkage of the community in question to the overall communication network, including for example bandwidth reservation, signaling events, etc. Thus the upper layer deals with macro network data found in Management Information Bases (MIB), and represents a gateway to the outside of the community, which has to be implemented/represented by at least one of the community members to allow the community to access the network's communication resources. The upper layer management of the present embodiment may be an operator controlled system (e.g. SNMP compatible) of the underlying network. This upper layer may be integrated into a hierarchical management system and has one or more management access points within a community. These access points are (higher) control points to the community, and the owners of these control points may be considered to be the owners or administrators of the community. The parties controlling these access points may advantageously also control the interface points between the two management layers described below.

A lower layer is for managing community-internal issues. It takes care of peer and community internal management, such as for example service provision. The lower layer agents have to be implemented by all community members.

A gateway module installed at an interface between management layers is a (lower) control point for the community, which is responsible for data exchange between the management layers. This interface between the two layers of community management is for conveying resource-related information, for example bandwidth allocations, from the upper layer (i.e. from the overlay network) to the lower layer of individual users in the community (i.e. community members). The kind of information exchanged over the management layer gateway may depend on a focus area of interest of the respective community, thus being different for each community. For example, for file sharing communities the exchanged information includes bandwidth reservation, traffic management and admission control information.

For implementation of the proposed community management in accordance with the above principles, only minor and fully standard-compatible modifications of the upper network management system are required.

The upper layer system defines a new branch in a Management Information Base (MIB) for the existing mobile communities. Any new registered community generates an own sub-branch under that “community” branch, wherein a community identifier (CID) is used for sub-branch identification. The structure of the new sub-branch is individual for each community and is defined based on identity card (IC) information and a set of community constraints.

An integration of the proposed community management scheme with the upper layer management system requires a full or partial deployment of a corresponding management agent (e.g. SNMP agent) on one of the community members, i.e. on one of the peers within the community in question. By default the community founder is responsible for allocating a gateway to the upper layer management system. The gateway can for example be deployed within the structure of its own mobile peer, unless some other community member decides to take this role. In practice, the provision of a gateway to the upper layer management system is one of the most natural roles for professional community members, e.g. commercial providers of resources and services. All the more as such a gateway provisioning may be rather expensive in terms of resource consumption taking into account resource limitations of mobile peers, professional and/or commercial members, usually having available more processing power than “private” members, are predestined for taking this role in communities that have a commercial nature. An example of such a community is a membership community administered by a credit card company.

In such an architecture, all community members contain a mobile agent module and might generate respective mobile agents for certain management tasks. In addition, the member that acts as a gateway to the upper layer management system contains a special community management module.

A mobile agent in this context is an application sent to perform activities in adjacent nodes, reporting back to the originating peer by transmitting messages, advantageously using the communication resources allocated to the community. A mobile agent can proceed further from the adjacent node to a further node adjacent to the adjacent node, and so on.

A use of mobile agents for community management turns out to be more efficient than the traditional manager-agent architecture. The first reason is the presence of a similar level (within one order of magnitude) of hardware equipment of all mobile community members. As the community manager has no advantage in terms of hardware equipment, the traditional manager-agent architecture creates unacceptably high pressure on it and results in regular loss of the management unit due to overload. Moreover, due to legal or some other reasons, the communities might be built based on the flat-structured principle. This case is also hard to address with the traditional manager-agent approach, whereas the proposed mobile agent solution does not have such problems. The second reason is an unpredictability of management tasks. A use of mobile agents for community management creates a more flexible management infrastructure that can be easily updated by introducing a new management mobile agent or by modifying the existing one.

In summary, the community management according to the present embodiment is based on mobile agents and constitutes a community-wide service managed by the peer in control of the gateway between the upper and lower community management layers.

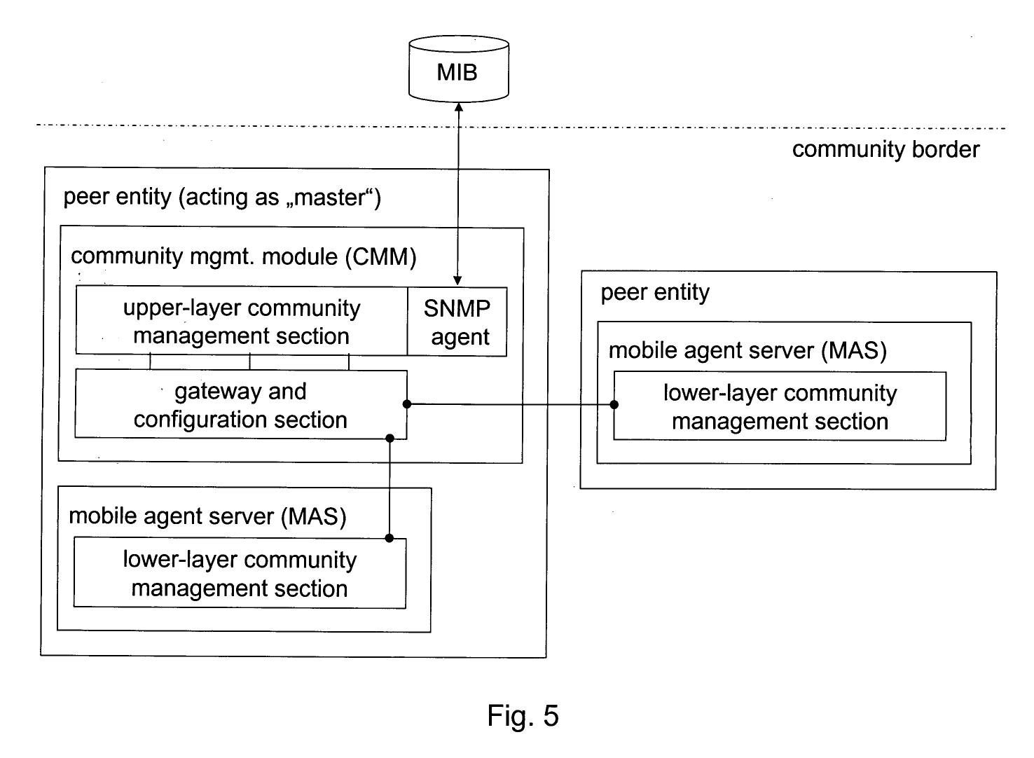

For a more illustrative presentation thereof, the above-described community management scheme is also illustrated by way of FIG. 5, which illustrates a schematic block diagram of a community management structure according to an embodiment of the present invention. It is further to be noted that the structure illustrated in FIG. 5 is based on an implementation example, and several modifications are conceivable within the overall principles of the present embodiment as described above.

According to FIG. 5, a hierarchical intra-community organization is taken as a basis. The master peer entity comprises both an upper management layer being denoted by community management module CMM and a lower management layer being denoted by mobile agent server MAS. The upper CMM layer comprises an upper-layer community management section being associated e.g. with an SNMP agent for providing an external gateway and a gateway and configuration section. The lower MAS layer comprises a lower-layer community management section. Peer entities not acting as master, only one of which is shown for the sake of lucidity, only comprises a lower management layer being denoted by mobile agent server MAS including a lower-layer community management section.

Management access points at the gateway and configuration section of the CMM layer of the master peer entity provide connections to the lower-layer community management sections within the community, i.e. both within the master peer entity and to other peer entities.

In this Figure, both upper layer and gateway management functions are in the same peer, but it is obviously possible that the responsibilities are split, e.g. with the upper-layer functions handled by an operator entity and the gateway and configuration functions controlled by a “master” peer.

### EXAMPLES

For illustrating implementation and realization of the proposed mobile community management system in respect of conceptual areas of network management, exemplary management applications are outlined in the following.

It is to be noted that mobile agents residing in the lower management layer can implement any one of the below management tasks, or any subset thereof.

i) A fault management is targeted at maintaining continuous availability and quality of services, which are strongly dependent on pruning and failure events happening with the community members. In mobile communities, a high mobility of the community members should also be taken into account. One way to manage faults is to leverage the aforementioned cooperativeness scores. A faulty peer will not be able to successfully provision services, thus its cooperativeness score will be downgraded several times, resulting in the peer no longer being selected for provision due to the unfavorable cooperativeness score. A low cooperativeness score can also be used to trigger fault correction measures.

The community management module may periodically generate fault management mobile agents that one by one visit all subordinate community members and return summary information to the manager entity. This may contain the cooperativeness scores of the members. In flat structured communities without a centralized management entity, each adjacent node is responsible for detecting a problem and for minimizing its impact to the provided services. In general, two strategies for handling such events are feasible: a proactive strategy that minimizes disturbance of the quality of provided services by the cost of additional signaling overhead, and a reactive strategy that might result in temporary degradation of the quality of service, but does not require extra signaling within the community. With the proactive scenario, the manager entity or adjacent nodes (depending on the type of organization) will start looking for replacement of failed resources by sending search requests (i.e. service request mobile agents) to the other community members, asking to help in finding another resource of similar competence and knowledge. This increases a connectivity ratio of the community, simplifies continuous preservation of the quality of guarantees, but requires additional resource investment without guaranteed payback. With the reactive scenario, a resource fault does not result in any action. The general assumption is that a replacement of the failed resource might be found upon an actual service request and that the requestor is ready to tolerate some degradation of the provided quality of service.

The proposed community management solution described above allows every community to select the fault handling strategy depending on the importance of the service availability and quality. A selection of the strategy may also depend on whether the failed resource is of replaceable or critical type. So, a selection of the strategy also depends on whether in the community restrictions (defined together with IC in the MIB) it is set that community members should be immediately notified about fault of the critical resource.

ii) A performance management takes care of monitoring quality of service provided to each community member. When the quality of service starts to decrease and there is a risk that it will fall below a predetermined level of user expectations, the user's device may generate a mobile agent for finding an alternative provider of the service. At any community member the mobile agent may define (using accessible local knowledge, for example cooperativeness scores or communication link qualities) the best direction for looking for an alternative source of the service. When it is found, the mobile agent returns to the originator and gives the shortest (direct, when possible) link to the new service provider.

Another important role of the performance management is to control that provision of requested services to the other community members does not harm the service-providing member. This means that the community member that created a popular service or has wide knowledgebase should not be punished for that. A special mobile agent may inform the rest of the community about unacceptable growth of the resource utilization on the service provider. As a consequence thereof, the mobile agent may try to duplicate the popular service and knowledge on other community members, but if it is not possible, it may force the service users to optimize use of the service.

iii) An accounting management addresses a target similar to that described above in connection with performance management. Both conceptual areas of network management are close to each other, and mechanisms for implementing them are related to each other. However, unlike the presented performance management mechanism, the accounting management is more reactive, which might lead to a sharp degradation of the provided quality of service. The accounting management functionality depends on the type of community member and might be targeted at resource access fairness and/or maximization of revenue.

A non-commercial community member mainly takes care of maintaining fair access to the provided services and resources by all community members. A commercial community member additionally uses mobile agents for proactive advertising of its provided services, contracting service access and billing.

iv) A configuration management plays a key role in creation and maintenance of intra-community relations. A general summary of community configuration information is included in an invitation mobile agent, which in addition to other data carries an IC message and community restrictions. When the invitation mobile agent arrives at a destination node, it initiates a community invitation procedure. Depending on the node configuration, the procedure might be performed in automated mode or request some actions from the user of the mobile device. The mobile agent may save identification and configuration information of the nodes, which express interest in joining the community, and provide these nodes with pointers to the community so that they can become peers. The community may periodically generate the configuration mobile agents, which serve for advertising community area of interest outside the community and for getting new members into the community. At the same time they are used for maintaining consistency of the management information of the community members. When the configuration mobile agent arrives at a community member, it checks whether a maintenance request flag is set, and if it is set, a member configuration update procedure may be launched. This update procedure collects information about changes in configuration happened on the node and then delivers it to the other relevant community members. The periodicity and a set of community members that have a right to generate the configuration mobile agents are defined as a part of the community restrictions.

v) A security management is targeted at protecting privacy of the community, preventing sabotage of the community rules and guaranteeing fair access to the resources by all community members. The security management principles are applied to all earlier mentioned mobile agents. Processing rules for the configuration (invitation) mobile agent on the non-community member nodes are defined by a node-internal security policy. The most often used strategies are to allow processing of the mobile agents originated by well-trusted sources (e.g. friends) and from sources that are guaranteed by a trusted third party (e.g. bank, operator).

According to the proposed community management, the concept of well-trusted sources is extended to community-trusted sources, which are created based on the feedback of the community members. The community members process (execute and forward) the mobile agent code only if it has a proper intra-community security signature, which is distributed as a part of the mobile agent configuration. The trust engines required to provide this trust information in communities are known to people skilled in the art.

<Further Aspects of Community Management>

The proposed community management solution has a specifically designed structure for incorporating. professional members in mobile communities, which results in a hybrid community type that mixes features of flat structured and hierarchical communities. The proposed two layer community management system also allows an easy integration of the operator's presence in the mobile community with the traditional centralized network/service management system. In this regard, the community management task itself might be seen as a potential area for ruling by a professional member, which is always available, well trusted and can cope with the management overhead.

A further issue with respect to community management is knowledge exchange between communities. In the mobile network, there is a high probability that a number of communities with similar areas of interest exist at the same time in different parts of the network. Another commonality of the communities might be based on the wish to share a subset of services for reducing service creation and maintenance cost. This creates a need for a mechanism that allows information exchange between communities.

This issue can be realized by the proposed two layer community architecture described above, which allows to use the upper layer for inter-community management. This feature is especially important for knowledge transfer from communities with a short life cycle. For example, fans of a rock group create a short-living community for exchanging photos during a concert. Such community is not longer needed and consequently not maintained after the concert, but some of the knowledge references might be interesting for outsiders, e.g. the best shot from the concert. The upper layer management allows to get access to information of that not-maintained community via the members that at the same time participate in another related community with longer life cycle. The knowledge sharing restrictions (rules) can be defined as trust relationships: the mobile agents searching for a certain service can obtain a community-trusted link to a peer in another community for the purpose of obtaining the service, in a manner similar to the way the agent obtains links within its own community. Thus two communities can exchange information almost automatically, if the trust information generated by the trust engine(s) is manipulated by community management.

Although embodiments of the present invention are described above mainly with respect to their principals, methods and operations performed, the present invention as a matter of course also covers respectively adapted and configured devices, modules, systems, computer programs and circuit arrangements for implementation of the described schemes in hardware and/or software.

In general, it is to be noted that respective functional elements according to above-described embodiments can be implemented by any known means, either in hardware and/or software, respectively, if it is only adapted to perform the described functions. The mentioned method steps can be realized in individual functional blocks or by individual devices, or one or more of the method steps can be realized in a single functional block or by a single device.

Furthermore, method steps and functions likely to be implemented as software code portions and being run using a processor at one of the entities are software code independent and can be specified using any known or future developed programming language such as e.g. Java, C++, C, and Assembler. Method steps and/or devices or means likely to be implemented as hardware components at one of the peer entities are hardware independent and can be implemented using any known or future developed hardware technology or any hybrids of these, such as MOS, CMOS, BiCMOS, ECL, TTL, etc, using for example ASIC components or DSP components, as an example. Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to those skilled in the art.

Generally, for the purpose of the present invention as described herein above, it should be noted that
a communication device or terminal may for example be any device by means of which a user may access a network and/or a server of such network; this implies mobile as well as non-mobile devices and networks, independent of the technology platform on which they are based; only as an example, it is noted that terminals operated according to principles standardized by the 3^{rd} Generation Partnership Project 3GPP and known for example as UMTS terminals (Universal Mobile Telecommunication System) are particularly suitable for being used in connection with the present invention, nevertheless terminals conforming to standards such as GSM (Global System for Mobile communications) or IS-95 (Interim Standard 95) may also be suitable;
networks referred to in this connection may comprise mobile and fixed network sections independent of the type of technology on which the networks are operated, for example those networks operate on the basis of the Internet Protocol IP, independent of the protocol version (IPv4 or IPv6), or on the basis of any other packet protocol such as User Datagram Protocol UDP, etc.
devices can be implemented as individual devices, devices may also be implemented as a module configured to accomplish interoperability with other modules constituting an entire apparatus, e.g. a module device may be represented as a chipset or chip card e.g. insertable and/or connectable to an apparatus such as a mobile phone, or a module may be realized by executable code stored to a mobile phone or other device for execution upon invocation.

Although the above description primarily relates to the proposed service provision and community management schemes on top of a peer-to-peer architecture, they are also applicable in other types of network organization. For example, the proposed schemes are usable for distributed management of conventional networks, while providing advantages of flexibility, bandwidth efficiency when the amount of management data exceeds an agent code size, and low requirements to hardware equipment.

Even though the invention is described above with reference to certain examples, it is clear that the invention is not restricted thereto. Rather, it is apparent to those skilled in the art that the present invention can be modified in many ways without departing from the spirit and scope of the inventive idea as disclosed herein above and as set out in the appended claims.

What is claimed is:

1. A method for provisioning a service within a community of nodes in a communication system, comprising:
issuing a request for a service at a first node of the community,
selecting, at the first node, a second node of the community for providing the requested service,
determining, at the second node, if the requested service is available at the second node, and
providing the requested service from the second node to the first node in response to the requested service being available at the second node.

2. The method according to claim 1, wherein providing the requested service from the second node to the first node further comprises:
requesting, by the first node, interpretable code for the requested service from the second node,
returning the interpretable service code from the second node to the first node, and
processing service data using the returned interpretable service code at the first node.

3. The method according to claim 1, wherein providing the requested service from the second node to the first node further comprises:
transmitting a service order including service data from the first node to the second node,
processing the service data utilizing local service code at the second node, thus producing a service deliverable, and
returning the service deliverable from the second node to the first node.

4. The method according to claim 1, further comprising:
forwarding the service request from the second node to a third node in response to the requested service being not available at the second node.

5. The method according to claim 4, wherein
the third node acts towards the second node as the second node towards the first node.

6. The method according to claim 4, wherein:
the third node communicates directly with the first node.

7. The method according to claim 1, further comprising:
grading a cooperativeness score of the second node at the first node in response to a result of determining service availability at the second node, wherein
the cooperativeness score of the second node is downgraded, if the requested service is not available at the second node, and
the cooperativeness score of the second node is upgraded, if the requested service is available at the second node.

8. The method according to claim 1, wherein selecting a second node is made using local information at the first node.

9. The method according to claim 1, wherein selecting a second node is made using a service identification.

10. The method according to claim 1, wherein selecting a second node is made using intra-community rules and information.

11. The method according to claim 1, wherein the community is a mobile peer-to-peer, P2P, community.

12. The method according to claim 1, wherein the requested service is a community management service.

13. The method according to claim 12, wherein the community management service comprises at least one of fault management, performance management, accounting management, configuration management, and security management.

14. A system for provisioning a service within a community of nodes in a communication system, comprising:
an issuance device configured to issue a request for a service at a first node of the community,
a selection device configured to select a second node of the community for providing the requested service,
a determination device configured to determine, if the requested service is available at the second node, and
a provision device configured to provide the requested service from the second node to the first node in response to the requested service being available at the second node.

15. The system according to claim 14, wherein the provision device further comprises:
a request device configured to request, for the first node, interpretable code for the requested service from the second node,
a returning device configured to return the interpretable service code from the second node to the first node, and
a processor configured to process service data using the returned interpretable service code at the first node.

16. The system according to claim 14, wherein the provision device further comprises:
a receiver configured to receive a service order including service data from the first node at the second node,
a processor configured to process the service data utilizing local service code at the second node, thus producing a service deliverable, and
a returning device configured to return the service deliverable from the second node to the first node.

17. The system according to claim 14, further comprising:
a forwarding device configured to forward the service request from the second node to a third node in response to the requested service being not available at the second node, wherein

18. The system according to claim 17, wherein:
the third node acts towards the second node as the second node towards the first node.

19. The system according to claim 17, wherein:
the third node communicates directly with the first node.

20. The system according to claim 14, further comprising:
a grading device configured to downgrade a cooperativeness score of the second node, if the determination device determines that the requested service is not available at the second node, and to upgrade the cooperativeness score of the second node, if the determination device determines that the requested service is available at the second node.

21. The system according to claim 14, wherein the community is a mobile peer-to-peer, P2P, community.

22. The system according to claim 14, wherein the requested service is a community management service.

23. The system according to claim 22, wherein the community management service comprises at least one of fault management, performance management, accounting management, configuration management, and security management.

24. An apparatus configured to act as a first node within a community of nodes in a communication system, comprising:
a unit configured to issue a request for a service, to select another apparatus acting as a second node within said community for providing the requested service, to request the service from the other apparatus, and to receive the requested service from the other apparatus.

25. The apparatus according to claim 24, wherein the unit is configured to request the service by requesting interpretable code for the requested service, and wherein the unit is configured to receive the requested service by receiving interpretable service code from the other apparatus and processing service data using the received service code.

26. The apparatus according to claim 24, wherein the unit is configured to request the service by transmitting a service order including service data to the other apparatus, and wherein the unit is configured to receive the requested service by receiving a service deliverable from the other apparatus.

27. The apparatus according to claim 24, wherein the unit is further configured to grade a cooperativeness score of the other apparatus in response to a result of determining service availability at the other apparatus, wherein the cooperativeness score of the other apparatus is downgraded, if the requested service is not available at the other apparatus, and the cooperativeness score of the other apparatus is upgraded, if the requested service is available at the other apparatus.

28. The apparatus according to claim 24, wherein the requested service is a community management service.

29. The apparatus according to claim 28, wherein the community management service comprises at least one of fault management, performance management, accounting management, configuration management, and security management.

30. The apparatus according to claim 24, wherein the unit comprises a mobile agent server, MAS.

31. An apparatus configured to act as a second node within a community of nodes in a communication system, comprising:
a unit configured to receive a request for a service from another apparatus acting as a first node within said community, to determine if the requested service is available at said apparatus, and to provide the requested service from said apparatus to the other apparatus in response to the requested service being available at said apparatus.

32. The apparatus according to claim 31, wherein the unit is configured to provide the requested service by returning, upon request, interpretable service code to the other apparatus.

33. The apparatus according to claim 31, wherein the unit is configured to provide the requested service by processing, upon request, service data provided by the other apparatus utilizing local service code, thus producing a service deliverable, and by returning the service deliverable to the other apparatus.

34. The apparatus according to claim 31, wherein the unit is configured to forward the service request received from the other apparatus to a third apparatus acting as a third node within said community in response to the requested service being not available at said apparatus.

35. The apparatus according to claim 34, wherein the third apparatus representing the third node acts towards said apparatus representing the second node as said apparatus representing the second node acts towards the other apparatus representing the first node.

36. The apparatus according to claim 34, wherein the third apparatus representing the third node acts towards the apparatus representing the first node as said apparatus representing the second node acts towards the apparatus representing the first node.

37. The apparatus according to claim 31, wherein the requested service is a community management service.

38. The method according to claim 37, wherein the community management service comprises at least one of fault management, performance management, accounting management, configuration management, and security management.

39. The apparatus according to claim 31, wherein the unit comprises a mobile agent server, MAS.

40. A computer program embodied on a computer-readable medium, comprising program code which, when executed on a node of a community of nodes in a communication system, causes the node to act as a node in a community, in which the method according to claim 1 is performed.

41. A method for managing a community of nodes in a communication system, comprising:
an upper-layer management process of managing community-external issues in terms of a relation between the community and the overlay communication system,
a lower-layer management process of managing intra-community issues in terms of a relation between the nodes of the community among each other, and
interfacing between the upper-layer management process and the lower-layer management process.

42. The method according to claim 41, wherein the upper-layer management process comprises:
a network management agent, and
a gateway and configuration management process of managing intra-community management configuration and a gateway to the lower-layer management process.

43. The method according to claim 41, wherein the lower-layer management process comprises:
a mobile agent server process for managing respective mobile agents for certain management tasks.

44. The method according to claim 43, wherein the lower-layer management process comprises at least one of fault management, performance management, accounting management, configuration management, and security management.

45. The method according to claim 41, wherein the community is a peer-to-peer, P2P, community.

46. An apparatus for managing a community of nodes in a communication system, comprising:
an upper-layer management module configured to manage community-external issues in terms of relationships between the community and the overlay communication system,
a lower-layer management module configured to manage intra-community issues in terms of relationships between the nodes of the community among each other, and
an interface between the upper-layer management module and the lower-layer management module.

47. The apparatus according to claim 46, wherein the upper-layer management module comprises:
a network management agent module, and
a gateway and configuration management module configured to manage intra-community management configuration and a gateway to the lower-layer management module.

48. The apparatus according to claim 47, wherein the network management agent module is operable for providing a gateway to a management information base, MIB, of the overlay communication system.

49. The method according to claim 46, wherein the lower-layer management module comprises:
a mobile agent server module for managing respective mobile agents for certain management tasks.

50. The apparatus according to claim 46, further comprising:
a mobile service module,
a fixed network module,
a service interpretation platform, and
a processor.

51. The apparatus according to claim 46, wherein the lower-layer management module is operable for performing at least one of fault management, performance management, accounting management, configuration management, and security management.

52. The apparatus according to claim 46, wherein the apparatus comprises a peer entity of a peer-to-peer, P2P, community.

53. A computer program embodied on a computer-readable medium, comprising program code which, when executed on a node of a community of nodes in a communication system, causes the node to act as an apparatus for managing the community according to claim 46.

54. A management application embodied on a computer-readable medium, comprising program code which, when executed on a node of a community of nodes in a communication system, causes the node to perform a method for managing the community according to claim 41.
